(19) United States
(12) Patent Application Publication
(10) Pub. No.: US 2022/0062918 A1
(43) Pub. Date: Mar. 3, 2022

(54) Apparatus and Method for Enhancing Filtration of Airborne Contaminants Via Eccentric Particle Movements

(71) Applicant: Don Hess, Dunedin, FL (US)

(72) Inventor: Don Hess, Dunedin, FL (US)

(21) Appl. No.: 17/009,524

(22) Filed: Sep. 1, 2020

(51) Int. Cl. B03C 3/017; B03C 3/019; B03C 3/41; B03C 1/023; B03C 1/23; B01D 46/00

(52) U.S. Cl. CPC B03C 3/017; B03C 3/019; B03C 3/41; B03C 1/023; B01D 2279/50; B01D 46/0032; B01D 46/0034; B03C 2201/22; B03C 1/23

(57) ABSTRACT

Disclosed is an apparatus for enhancing filtration. Enhanced filtration is promoted via the eccentric movement of charged particles within a defined space. This eccentric movement causes the charged particles to collide and conglomerate. The conglomeration, in turn, improves the efficiency of downstream filer media.

### TECHNICAL FIELD

This disclosure relates to a filtration apparatus for airborne particles. More particularly, the disclosure relates to a filtration apparatus with means for promoting eccentric particle movements, with the movements increasing both particle collisions and filtration efficiencies.

### BACKGROUND OF THE INVENTION

Increasing indoor air quality has become critically important in recent years. This is especially true in hospitals and clean rooms. But it is equally important to eliminate or reduce allergens, bacteria, and even viruses from residences and workplaces. Airborne contaminants can be either aerosols or gases. Aerosols are composed of either solid or liquid particles, whereas gases are molecules that are neither liquid nor solid and expand indefinitely to fill the surrounding space. Both types of contaminants exist at the micron and submicron level.

Most dust particles, for example, are between 5-10 microns in size (a micron is approximately 1/25,400th of an inch). Other airborne contaminants can be much smaller. Cigarette smoke consists of gases and particles up to 4 microns in size. Bacteria and viruses are another example of airborne contaminants. Bacteria commonly range anywhere between 0.3 to 2 microns in size. Viruses can be as small as 0.05 microns in size.

What is needed, therefore, is a filtration apparatus with increased efficiencies and that is more effective at eliminating submicron sized particles. The filtration apparatus of the present disclosure is designed to fulfill these and other shortcomings present with existing filtration systems.

### SUMMARY OF THE INVENTION

It is therefore an object of the present disclosure to provide an apparatus with increased filtration efficiencies and that can effectively remove submicron sized contaminants.

Another object of this disclosure is to promote eccentric particle movements, increased collisions, and otherwise facilitate the conglomeration of airborne contaminants.

Increased inelastic collisions are promoted in the present apparatus via static and alternating electromagnetic fields.

Another object is to condition particles prior to filtration via eccentric particle movements.

Another advantage is realized by generating a magnetic field via a voltage at a set frequency, and thereby causing ionized particles to move eccentrically.

The magnetic field creates torque on the conditioned particles to decrease the mean free path of collisions.

Various embodiments of the invention may have none, some, or all of these advantages. Other technical advantages of the present invention will be readily apparent to one skilled in the art.

### BRIEF DESCRIPTION OF THE DRAWINGS

For a more complete understanding of the present disclosure and its advantages, reference is now made to the following descriptions, taken in conjunction with the accompanying drawings, in which:

FIG. 1 is a diagram of the filtration apparatus of the present disclosure.

FIG. 2 is a diagram of an alternative embodiment of the filtration apparatus of the present disclosure.

FIG. 3 is a diagram of an alternative embodiment of the filtration apparatus of the present disclosure.

Similar reference numerals refer to similar parts throughout the several views of the drawings.

### DETAILED DESCRIPTION OF THE DRAWINGS

The present disclosure relates to an apparatus and method for enhancing filtration. Increased filtration efficiencies are achieved by first ionizing particles within a defined space. Thereafter, via changing electromagnetic fields, the charged particles are forced to undergo eccentric movements. This eccentric movement promotes inelastic collisions between the charged particles and ultimately conglomeration. A variety of airborne contaminants can be bound within the conglomeration. The conglomeration, in turn, improves the efficiency of downstream filer media. The various components of the present apparatus, and the manner in which they are interrelated, are described in greater detail hereinafter.

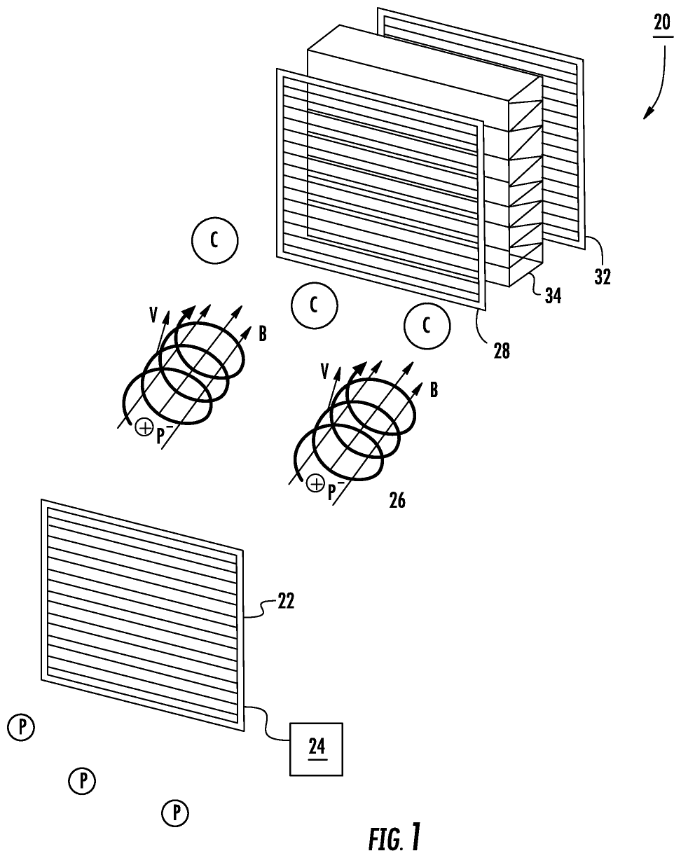

As illustrated in FIG. 1, the apparatus 20 includes a first grid 22 for receiving the airborne particles P to be filtered. A first voltage supply 24 is connected to this first grid 22. The first voltage electrifies grid 22 at a sufficiently high negative voltage to ionize nearby particles P. These nearby particles P become negatively charged P− after passage through grid 22. The particles receiving this charge can consist of any of a wide variety of known airborne contaminants. These contaminants can include, for example, smoke, dust, pollen, dander, bacteria, or viruses. The preferred process of ionization is described in greater detail below. Only after the particles P are ionized do they pass through the first grid 22.

The first voltage 24 also supplies an alternating voltage at a set frequency to the first grid. In accordance with Maxwell's Fourth Equation/Faraday's Law, this alternating voltage generates a magnetic field B around first grid 22. Magnetic field B has a field strength that impacts the movement of ionized negative particles P− following their passage through first grid 24. Namely, the resulting magnetic field B applies a torque to the particles P− following their passage through first grid 22. This torqueing is referenced in FIG. 1 via lines 26. This torquing causes the ionized particles P− to move erratically and collide with one another and create larger conglomerated particles C.

In an important aspect of the disclosure, the strength of the magnetic field B increases as the frequency of the voltage increases. Namely, an alternating frequency of the voltage generates a magnetic field B having a force that is determined in accordance with Faraday's Law and Lawrence's Equation F=qE+(qv×B). This is the force promoting the eccentric path 26 of the negative particles P−. In particular, the varying force promotes a cork screw like path 26 for the particles. This eccentric path promotes particle collisions and conglomeration, by reducing their mean free path and creating inelastic collisions between particles. Conglomeration, in turn, increases the efficiency of downstream filters 34.

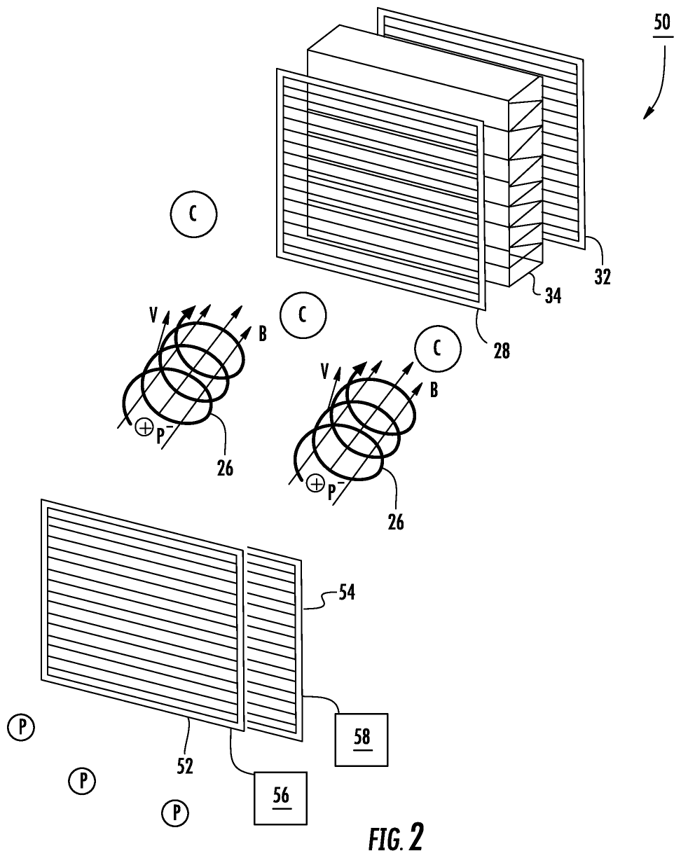

In an alternative embodiment of the invention is illustrated in FIG. 2. This embodiment is the same in most respects to the first embodiment and similar reference numerals are used to signify similar components. However, apparatus 50 employs two separate grids (primary grid 52 and secondary grid 54) instead of a single grid. Primary grid 52 is connected to an ionizing voltage source 56 and secondary grid 54 is connected to an alternating voltage source 58. Ionizing voltage source 56 supplies a voltage that is sufficiently high to ionize nearby particles P. Grid 54 can be placed in close proximity to grid 52. Magnetizing voltage source 58 supplies an alternating voltage to grid 54 that is sufficient to generate a magnetic field B. As noted in the primary embodiment, the ionized particles leaving the primary grid 52 are subsequently torqued when passing through secondary grid 54. In all other respects, this alternative embodiment is the same as the first embodiment.

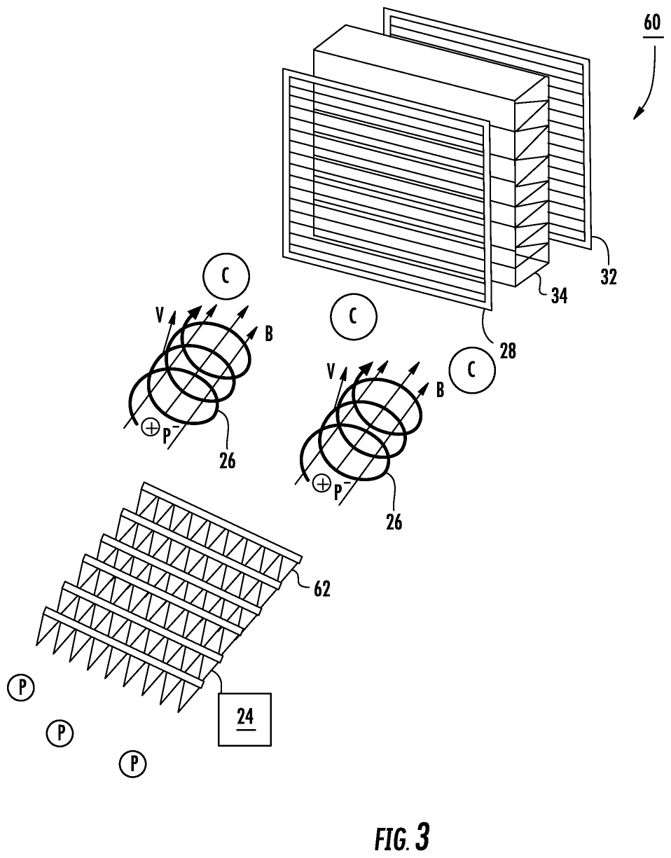

A third embodiment of the present disclosure is illustrated in FIG. 3. FIG. 3 illustrates an apparatus 60 that is the same in most respects to the first embodiment and similar reference numerals refer to similar components. However, this embodiment employs a grid 62 that is formed from a series of serrated blades. These blades are connected to voltage source 24. As with the primary embodiment, the purpose of this voltage source 24 is to ionize the particles P near the grid 62. In this embodiment, the sharp point of the serrations allow the electrical field to be significantly concentrated. When the electrical field is strong enough, charges are emitted to the surrounding space to develop a space charge. It is also within the scope of the present disclosure to use thin metal wires in lieu of the serrations.

### Ionization

Particle ionization occurs when a particle passes through an ion field. One type of ion field is a corona field. A corona field is created when a voltage is passed through a very thin wire or a thin metal blade with a serrated edge. Upon application of the voltage, electric fields concentrate on a sharp point and on a thin edge. When the electric field is strong enough, charges are emitted to the surrounding space, thereby developing a space charge. For example, if a negative high voltage is applied to a thin wire or metal edge, electrons are emitted to the air surrounding the wire or blade. When a particle passes through this created electron field, the particle picks up, or acquires, some of the electrons and becomes a negative ion (this also applies to a positive field which produces a positive ion). In the case of a particle passing through the negative ion field (electrons) the particle becomes negatively charged, thereby allowing its movement to be controlled by the subsequent application of another electric field. If a grid that has the same voltage applied to it as the corona grid is placed in the path of the particle, the particle will be repelled by the grid (like charges repel each other). Furthermore, if a positive wire is placed downstream from the negative wire the conditioned particle will be propelled towards this positive grid (unlike charges attract each other). This is how the trajectory of particles can be controlled using precisely controlled electromagnetic, electrostatic, and/or electrodynamic fields.

### Subsequent Filtration

After the ionized particles P− are torqued by magnetic field B, inelastic collisions are promoted. These inelastic collisions create larger conglomerated particles P. These conglomerated particles may comprise a variety of different contaminants and are large enough to greatly improve the efficiency of downstream filter media. Any of a variety of known filter media can be used in connection with apparatus 20. In particular any of the filtration systems disclosed in the present inventor's prior patents may be employed for downstream filtration. These patents include U.S. Pat. Nos. 9,468,935; 9,028,588; 7,803,213; 7,404,847; and 7,175,695. The content of all these patents are fully incorporated herein for all purposes.

In each of the depicted embodiments (FIGS. 1-3), the downstream filtration is achieved via additional downstream grids (28 and 32) and a filter media 34. Grid 28 creates a strong electrostatic field to form dipoles within conglomerated particles C. This means that one end of the particle is positively charged, and the other end is negatively charged. This polarization is due to the fact that opposite charges attract and like charges repel. When a particle approaches a strong electrostatic field, such as a −15 kV field, a dipole is formed. Every atom in a particle is composed of a positively charged nucleus and a negatively charged ion cloud, surrounding the nucleus. The electrons are at different energy levels, described by quantum mechanics, surrounding the nucleus. When entering the negative ion cloud the positive nucleus will be pulled toward the ion field and the negatively charged electrons will repel. The particle forms a dipole, (p=qd). Once the above process occurs the particle passes through the electrostatic field, combine with other particles and become neutral in charge.

Some of the positive charges in the particle will move toward the strong field (front of the particle) and some of the negative charges will move towards the opposite end (rear) of the particle, away from the static field. Once this occurs the particle passes through the electrostatic field. A second electrostatic field can be created via grid 32. Grid 32 creates a potential that is opposite of the electrostatic field created by grid 28. Thus, particles C are propelled from first grid 28 to the second grid 32 and through filter media 34. This, in turn, further enhances filtration efficiencies.

Controlled Particle Colliding performs at least two functions. First, it causes collisions between sub-micron sized particles to form larger particles, thus changing them from being dominantly controlled by electromagnetic fields to being controlled by airflow. Second, it makes particles neutral in charge. Particles will not only stay entrained in the airflow without being influenced by the electromagnetic fields in the room environment but will not be as likely to form strong bonds with surfaces and objects in the room, even if they should come in contact with them.

Although this disclosure has been described in terms of certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure.

What is claimed is:

1. An apparatus for enhancing filtration of airborne particles comprising:
a first grid for receiving the particles to be filtered, a first voltage supply connected to the first grid, the first voltage supply electrifying the grid and ionizing the particles passing therethrough to generate negatively charged particles;
a second grid in close proximity to the first grid, a second voltage supply connected to the second grid, the second voltage supply creating a magnetic field via an alternating voltage at a set frequency, the magnetic field having a field strength that impacts the movement of the negatively charged particles;
whereby the magnetic field torques the negatively charged particles passing through the second grid to promote inelastic collisions and create conglomerated particles;
filter media positioned downstream of the second grid for filtering the conglomerated particles.

2. An apparatus for enhancing filtration of airborne particles comprising:
a grid for receiving the particles to be filtered, a voltage supply connected to the grid, first voltage supply electrifying the grid and ionizing the particles passing therethrough to generate negatively charged particles, the voltage supply also creating a magnetic field via an alternating voltage at a set frequency, the magnetic field having a field strength that impacts the movement of the negatively charged particles;
whereby the magnetic field torques the negatively charged particles passing through the grid to promote inelastic collisions and create conglomerated particles;
filter media positioned downstream of the grid for filtering the conglomerated particles.

3. The apparatus as described in claim 2 wherein the particles consist of a variety of contaminants.

4. The apparatus as described in claim 2 wherein the torque causes the negative particles to travel in an eccentric path.

5. The apparatus as described in claim 2 wherein the torque causes the particles to travel in a corkscrew path.

6. The apparatus as described in claim 2 wherein an additional electrical grid is included for forming dipoles from the conglomerated particles.

7. A method for enhancing filtration, the method comprising the following steps:
electrifying particles to be filtered via an ionizing voltage, the ionization creating negatively charged particles;
subjecting the negatively charged particles to a magnetic field, the magnetic field causing the negatively charged particles to collide and conglomerate;
filtering the conglomerated particles.
